(19) United States
(12) Patent Application Publication
(10) Pub. No.: US 2013/0160254 A1
(43) Pub. Date: Jun. 27, 2013

(54) Combination Chain Tensioning Boom and Tensioning Sensor

(71) Applicant: James Marshall Stoddard, Craig, CO (US)

(72) Inventor: James Marshall Stoddard, Craig, CO (US)

(21) Appl. No.: 13/775,691

(22) Filed: Feb. 25, 2013

Related U.S. Application Data
(62) Division of application No. 12/798,774, filed on Apr. 9, 2010.
(60) Provisional application No. 61/212,402, filed on Apr. 10, 2009.

(51) Int. Cl. B60P 7/08

(52) U.S. Cl. CPC B60P 7/0861
USPC 24/68 CD

(57) ABSTRACT

A system and device that measures the cargo load securing tension upon a tensionable cargo load securing line including but not limited to a woven web, belt, cord, chain having a tension boom and conveys tension information sensed in the tension boom to a remote location is presented. Utilized is an “indirect” form of tension information conveyance, that being radio, light or sound, or a “direct” form of signal conveyance, that being wire or vehicle ground system or vehicle frame. Various remote locations may receive conveyed tension signal. They may include receiver devices located within transportation vehicle power unit cab, visual display on anterior portion of haul unit, transportation operator wrist or clothing mounted device, satellite linked management or office facility, associated convoy vehicle cab or operator, or other. Cab and operator tension display devices may provide an array of tension analysis recording and view and travel assist options.

### CROSS-REFERENCE TO RELATED APPLICATIONS

This application is a divisional application filed under 35 USC 111(a) and 37 CRF 1.53(b) of U.S. patent applicatio Ser. No. 12/798,771 filed Apr. 9, 2010 of common inventorship, now abandoned. This application also claims the benefit of provisional application No. 61/212,402 filed Apr. 10, 2009 under 35 USC 119(e).

### BACKGROUND OF THE INVENTION

### Field of Invention

This invention relates to all forms of anchoring type devices including but not limited to tie strap, ratchet strap and chain and boom type tensioning cargo hold down devices including those securing structures in high winds. The present invention electronically monitors hold down tension and through electronic and mechanical means, communicates to the operator who can monitor load and tension status from virtually any location. It utilizes conventional and accepted means of electronic detection, interpretation and signal conveyance to various forms of conventional and accepted indicators utilizing sound, light, vibration, and or analog or digital forms of display. The present invention's transportation embodiment is unique in that it permits the immediate, real time evaluation of a cargo load's securement status while in motion and underway. Prior to this invention, transportation load status was only possible to evaluate by an immediate stop for physical inspection, exposing transportation operator to potential hazards including inclement weather, traffic, unsteady and shifting loads as well as the inconvenience and loss of production time associated with a full stop. This device can profoundly increase safety for cargo loads and individuals alike as well as increase production as load status can be carefully monitored while in motion. The improvement to highway safety alone will be profoundly beneficial as hundreds of people are killed or injured every year as a result of transportation load securement failure. Load securing systems have been in existence for thousands of years. Of late however, U.S. Pat. No. 4,487,537 to Morse 1984 details the secure attachment of a drum to a transportation flat bed with chains straps and tensioning devices but fails to offer any notification to the operator if a tensioning device or chain anchor fails, even having mentioned that some attempts at drum securement have indeed failed. Transportation air pressure monitoring is outlined by U.S. Pat. No. 5,602,524 to Mock et al and logically, safety and efficiency are maximized by providing tire pressure information to the operator. Some remotely related marine tethering issues are addressed by several patents including U.S. Pat. No. 4,912,464 to Bachman in which motion in a boat's anchor is communicated via sonar to a receiver in the boat's hull thus notifying the operator of potential and undesired movement occurring in an anchored boat. The details of U.S. Pat. No. 5,284,452 to Corona 1984 outlines how excessive tension in mooring lines is monitored and transmitted to a signal array atop mooring buoy but the signal is not transmitted to any operators and the essence of the patent is based on too much tension, not too little tension as the present invention details. The art of monitoring strain and stress in a building or bridge has been dedicatedly addressed by U.S. Pat. No. 5,086,651 to Westermo et al. but a dedicated and affordable device that reads the tension of a transportation tie down and communicates to the operator seems as yet necessary and as yet unavailable.

### SUMMARY

It remains one of civilization's profound objectives to improve roadway safety and reduce property loss, damage and destruction to the cargo items perpetually in transit in our nation. The information provided to the transportation operator utilizing this type of tie strap tension monitoring device will contribute significantly to both objectives. The value of immediate knowledge of chain boom tension failure on a large load will greatly exceed the value of the post event knowledge of a complete load securement failure resulting in roadway closure, property damage and a tragic loss of life. The present invention affordably addresses all types of securing systems from a modest motorcycle on a single axle trailer to a 25 ton gravel crusher on a multi axle flat haul unit. Further advantages will become apparent from a study of the following description and the accompanying drawings.

### BRIEF DESCRIPTION OF THE DRAWINGS

FIG. 1 is a large scope, conceptual side view of the present invention's preferred embodiment.

FIG. 2 is a ¾ view of the “thread through” embodiment of tension sensing device.

FIG. 3 is a ¾ view of the “clamp on” embodiment of tension sensing device in the un-clamped or open configuration.

FIG. 4 is a ¾ view of the “clamp on” embodiment of the tension sensing device in the clamped or closed configuration.

FIG. 5 is a ¾ view of the “clip on” embodiment of the tension sensing device in the closed configuration.

FIG. 6 is a ¾ view of the “clip on” embodiment of the tension sensing device in the open configuration,

FIG. 7 is a ¾ view of embodiment combining tension sensing device and tie-down tensioning device into the same assembly.

FIG. 8 is a side view of conventional “Chain tensioning boom” in both open and closed configurations.

FIG. 9 is a ¾ view of in line chain type embodiment of tension sensing device.

FIG. 10 is a side view of an attachable tension monitoring device upon a pre-installed, hold down chain.

FIG. 11 is a side view of a “smart link” chain tension monitoring device designed to function within a tie down chain.

FIG. 12A is a front view of basic cab display unit.

FIG. 12B is a ¾ view of optional portable display unit.

FIG. 13 is an electrical schematic for basic tie down tension sensing embodiment

FIG. 14 is a ¾ view of a trailered, transported load, secured and fitted with both a permanent and positional tension status display.

FIG. 15 Shown is a schematic of the general relationship between the tie strap tension and the creation of tension status signal.

### DETAILED DESCRIPTION

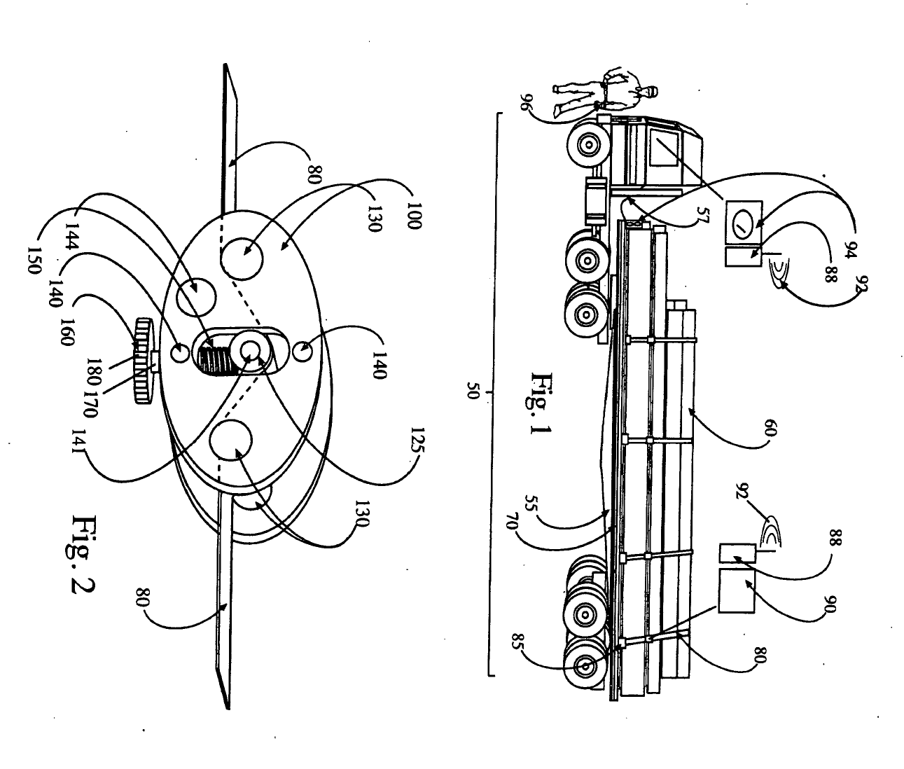

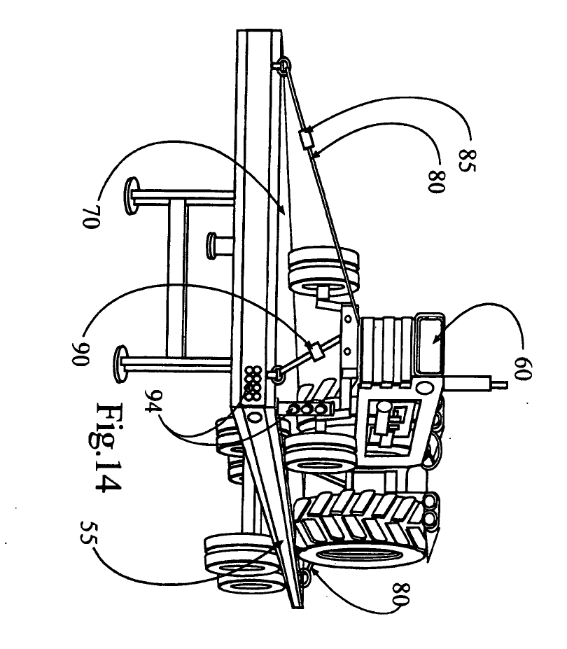

FIG. 1. Shown is a conceptual side view of preferred embodiment. Transportation unit 50 with transported load 60 is bound and secured to transportation deck 70 by multiple securing straps 80 and adjustably tightened by tensioner device 85. Tension monitoring device 90 evaluates strap tension and communicates information 92 to cab and remote display devices 94 (FIG. 12A) and 217 (FIG. 12B) respectively. Securing, tie-down straps 80 may be constructed of any durable material and tensioning devices may be integral with tie-strap material or built into transportation deck 70. Tension information 92 may be communicated via some form of light/radio conveyance means “indirect” or a hard wired “direct” through dedicated wire, transportation unit 50 wiring system and/or frame 57. Tensioning device 85 may also function as a continuous unit with tension monitoring device 90. Display unit 94 may be permanently installed into transportation unit or removably mounted. Portable display unit 217 may utilize all forms of information conveyance means including radio, light, cell phone signal or even satellite compatible means.

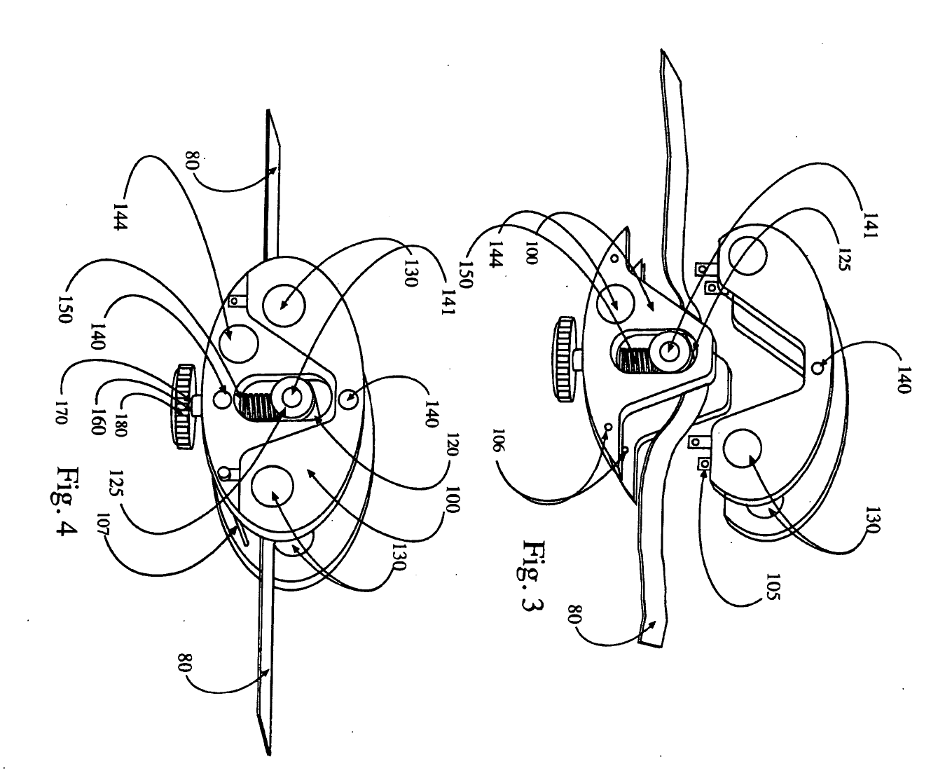

FIG. 2 This ¾ view of the “thread through” embodiment of tension sensing device details the function of the present invention while utilizing the flat, belt type tie-down material 80. Belting is positioned under pin/roller 130 and threaded inwards over roller 125 which contains electromagnetic initiator/trigger 141 and is spring loaded by spring 150. Spring tension on roller 125 is adjustable through shaft 170 and rotationally tightened or loosened with knob 160. Tactile grip on knob 160 is enhanced by texture teeth 180. Prior to exiting device, tie-strap belting 80 lastly passes under second pin/roller 130 and proceeds to secure anchor point. Sensor/switch 140 (2 shown) functions to identify relative location of roller 125 which responds to tie strap tension and utilizing power and electromagnetic conditioning supplied from behind access panel 144 convey location information to display devices 94 (FIG. 12A) and 217 (FIG. 12B) This diagram conceptualizes radio information conveyance means and other embodiments may utilize a “direct” form of conveyance namely a wire or vehicle frame conduction or a combination of the two or other. Countless variations of transducer/tie-strap motion interface are feasible and available. This embodiment has been selected to convey the general concept with simplicity and is not intended to limit scope of specification.

FIG. 3. The ¾ view of the “clamp-On” embodiment resembles the details outlined in FIG. 2 with the differences centering around the clamp-on, split able nature of shown embodiment. As shown in its open configuration, lock pin holes 106 can be identified in lower housing 100B and lock tabs 105 are shown descending from upper housing 100A. The fundamental purpose of this embodiment permits the quick and simple installation of tension sensing device upon a securing strap 80 that is pre-installed and possibly pre-tensioned. Other embodiments may utilize various different types of locking mechanisms. Countless variations of transducer/tie-strap motion interface are feasible and available. This embodiment has been selected to convey only the general concept with simplicity and is not intended to limit scope of specification.

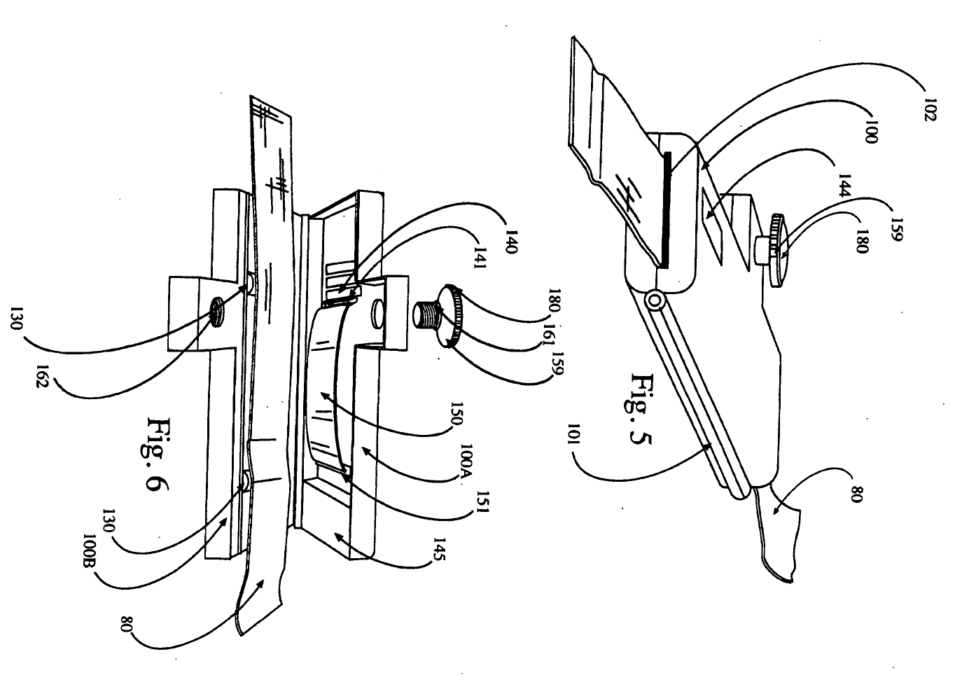

FIG. 4 The ¾ view of the “clamp-On” embodiment resembles the details outlined in FIG. 2 with the differences centering around the clamp-on, split able nature of shown embodiment. As shown in i's closed configuration, lock pin 107 is identified securing upper housing 100A to lower housing 100B through Locking tabs 105 (FIG. 3) and locking holes 106 (FIG. 3). The fundamental purpose of this embodiment permits the quick and simple installation of tension sensing device upon securing strap 80 that is pre-installed and possibly pre-tensioned. Countless variations of transducer/tie-strap motion interface are feasible and available. This embodiment has been selected to convey only general concept with simplicity and is not intended to limit scope of specification.

FIG. 5 This ¾ view of the “clip-On” embodiment presented in FIG. 5 details the housing 100 in a closed configuration and secured with the tightening of closure knob 159. Also shown is securing strap 80, hinge 101, weather resistant slot 102 and access panel 144. The fundamental purpose of this embodiment permits the quick and simple installation of tension sensing device upon securing tie-strap 80 that is pre-installed and possibly pre-tensioned. Countless variations of transducer/tie-strap motion interface are feasible and available. This embodiment has been selected to convey only concept with simplicity and is not intended to limit scope of specification.

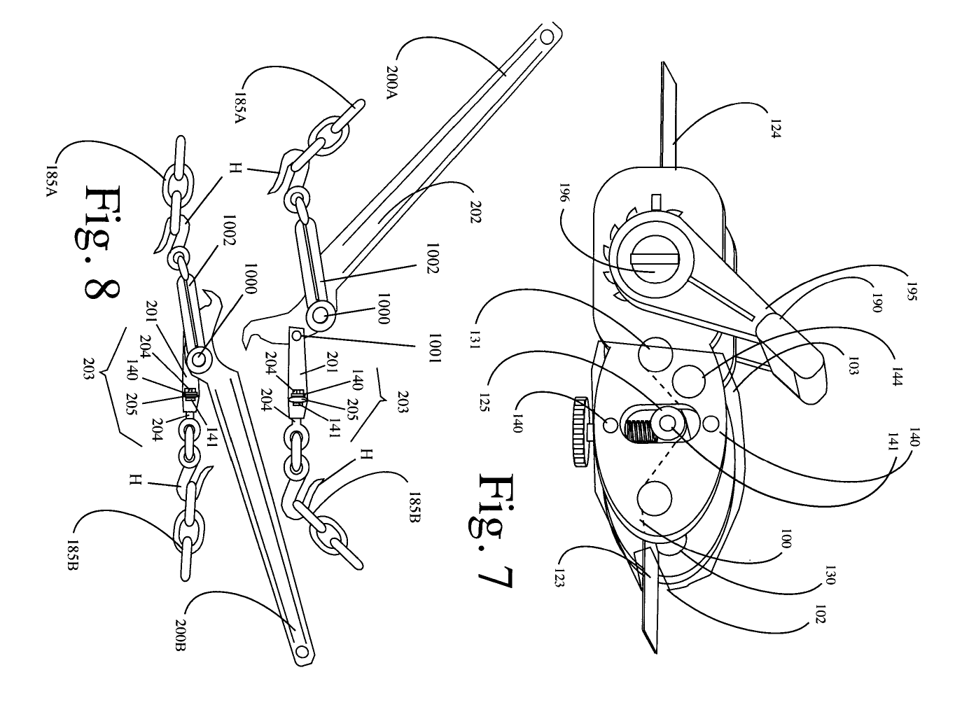

FIG. 6 The ¾ view of the “clip-on” embodiment presented in FIG. 6 details the hinged 101 open configuration of tension sensing embodiment with securing strap 80 in position, first entering housing 100 through weather resistant slot 102 and resting on pin/roller 130. The upper housing 100A contains electrical component enclosure 145, spring 150, spring attachment point 151 and appropriately attached to sliding portion of spring 150, electromagnetic initiator/trigger 141. In sliding contact with and responding to electromagnetic initiator/trigger 141 embedded in sliding portion of spring 150 sensor/switch 140 firmly anchored to upper housing 100A respond to position of electromagnetic initiator/trigger as a result of strap tension and conveys positional electrical information to electronics in electrical component enclosure 145 for processing and conveyance to display devices 94 (FIG. 12A) and 217 (FIG. 12B) Spring 150, possesses resilient nature to precisely respond to tension variations in strap 80. Logically, spring responds to increase in strap tension 80 and experiences a “straitening” effect resulting in alterations in relative positions of electromagnetic initiator/trigger 141 and sensor/switch 140. Countless variations of transducer/tie-strap motion interface are feasible and available. This embodiment has been selected to convey only general concept with simplicity and is not intended to limit scope of specification.

FIG. 7 This ¾ view of tension sensing embodiment is shown combined with tie-down tensioning device. Securing straps in this embodiment are shown in 2 distinctive segments, stationary tie strap segment 123 and tension able tie strap segment 124. Stationary tie strap segment 123 does not possess adjustable or tension able character and functions to provide tension information to electronics located behind access panel 144 and also to tie-off entire strap assembly. Tie-strap segment 123 initiates on its first end within housing 100 on tie-off pin/roller 131. It then is permanently threaded over spring loaded roller 125, under roller/pin 130 and then exits housing 100, terminating on its second end, optionally with an “s” hook (not shown) or other fixed type of anchor. Tension sensing mechanism creating tension information shown in this embodiment resembles tension sensing mechanism outlined in FIG. 2. Tensionable tie strap segment 124 is adjustable and is spool able on spool hub 196 which is driven manually through ratchet lever 195 and handle 190. Detail of ratchet mechanism is not provided here as it is beyond the scope of this work. Entire tensioning assembly is encloseable in weather resistant enclosure 103.

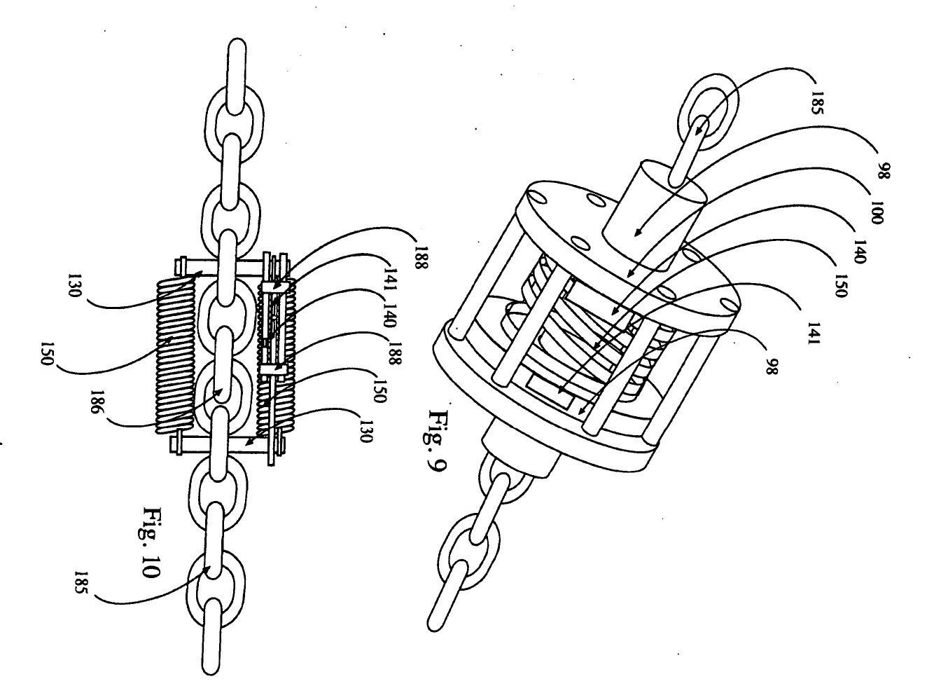

FIG. 8 shows a side view of a conventional “chain tensioning boom” in both, open 200A and closed 200B configurations. Close examination will reveal tension sensing assembly 203 with tension sensing unit 201. Tension sensing assembly 203 is composed of compressible bushing 205 (which resembles the function of spring 150) of FIG. 6, tension plunger 204, electromagnetic initiator/trigger 141 positioned on head of tension plunger 204 and sensor/switch 140, located on body of tension sensing unit 201. When tension is applied to the second chain segment 185B by boom lever 200B over a secured load, compressible bushing 205 is compressed and allows the distance between electromagnetic initiator/trigger 141 and sensor/switch 140 to be reduced, thus creating an electronic signal that is conveyable to a display. Selection of the precise nature of the electromagnetic initiator/trigger 141 and sensor/switch 140 will determine the sensitivity of tension sensing unit 201 as well as cost to manufacture. Transportation equipment demands vary and require varying forms of this embodiment. The chain tensioning boom 200A has a first pivoting joint 1000 connected to a chain linkage assembly 1002 which has a hook H connected to the first chain segment 185A. The chain tensioning boom 200A has a second pivoting joint 1001 which secures a proximal end of the tension sensing unit 201. The distal end of the tension sensing unit 201 has a sliding engagement, not shown, with the tension plunger 204. The tension plunger 204 is connected to the second chain segment 185B by a hook H.

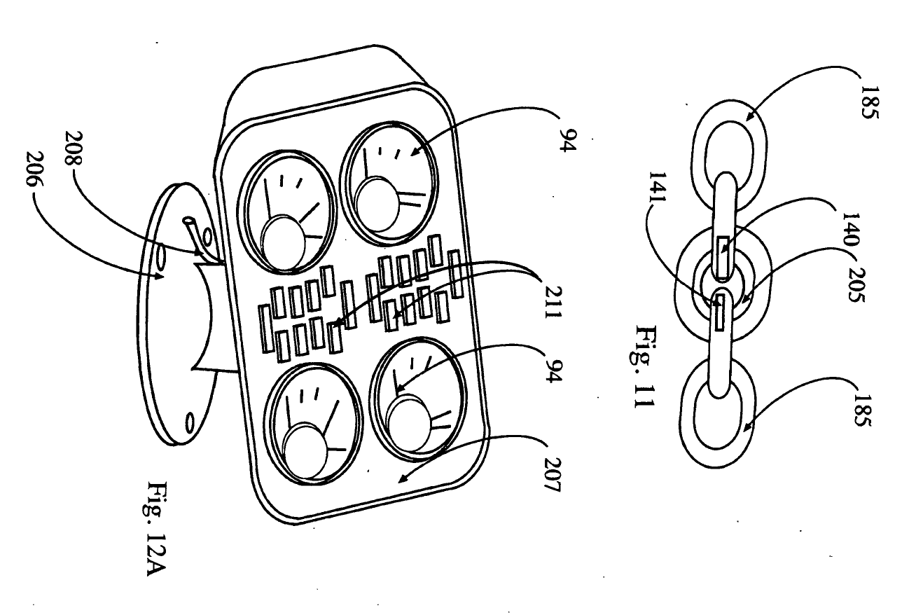

FIG. 9 Shown is a ¾ view of in line chain type embodiment of tension sensing device. This heavy duty embodiment allows chain or heavy duty canvas or nylon belting to attach directly to chain end links 185 of first end of tension sensing unit allowing second end of unit to be attached to another chain or fixed anchor. As tension is applied to tension sensing unit at link chain 185, sliding portion of tension sensing device 98 will begin to move out of housing 100. This action will compress spring 150 and, at full tension, sensor/switch 140 and electromagnetic initiator/trigger 141 will be in immediate proximity of one another. The loss then, of any tension on tension sensing unit will conversely allow sliding portion of tension device 98 to slide back into housing 100. Spring 150 decompresses and logically electromagnetic initiator/trigger 141 and sensor/switch 140 will move away from one another creating the conveyable signal to display. Selection of precise nature of electromagnetic initiator/trigger 141 and sensor/switch 141 will determine sensitivity of tension sensing unit as well as cost to manufacture. Transportation equipment demands very and require varying forms of this embodiment. This embodiment has been presented in very general terms to convey only the general concept.

FIG. 10. Shown is a side view of an attachable tension monitoring device installable upon a pre-installed, hold down chain. This tension sensing device must be installed in a link chain prior to tensioning as link chain slack 186 in necessary to establish tensioning of springs 150. Upon tensioning, sliding plate possessing sensor/switch 140 and attached to pin/roller 130 moves toward electromagnetic initiator/trigger 141. Tension sensing assembly, composed of sliding plates supporting sensor/switch 140, and electromagnetic initiator/trigger 141 and loosely bound together with retaining clips 188 is fitted into and protected by second spring 150. Potential loss of tension allows springs 150 to pull together roller/pins 130 and, in so doing, distance between sensor/switch 140 and electromagnetic initiator/trigger 141 increases thus creating a conveyable signal to display. Selection of precise nature of electromagnetic initiator/trigger 141 and sensor/switch 140 will determine sensitivity of tension sensing unit as well as cost to manufacture. Transportation equipment demands very and require varying forms of this embodiment. This embodiment has been presented in very general terms to convey only the general concept.

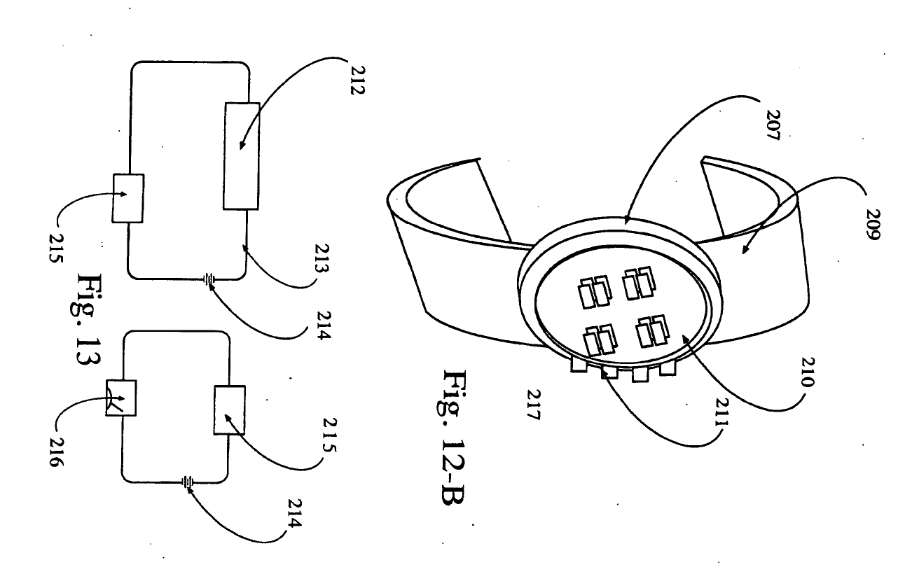

FIG. 11 Shown is a side view of a “smart link” chain tension monitoring device designed to function within a tie down securing chain. Very simply, the function of this embodiment resembles that shown in FIG. 10 in that the essence of the creation of the conveyable signal is the increase in distance between the sensor/switch 140 and the electromagnetic initiator/trigger 141. Fewer mechanical parts are required in this embodiment as with the outward increase in tie-down chain tension upon both chain links 185, the compression of the compressible bushing material 205(which function resembles universal spring 150) permits sensor/switch 140 to move away from electromagnetic initiator/trigger 141 as the link carrying electromagnetic initiator/trigger 141 has also been pulled away from sensor/switch 140 and too has compressed compressible bushing material 205. Logically with release of pressure, resilience of compressible bushing pushes both links, one possessing sensor/switch 140 and the other possessing electromagnetic initiator/trigger 141 away from one another thus creating conveyable signal. Selection of precise nature of electromagnetic initiator/trigger 141 and sensor/switch 140 will determine sensitivity of tension sensing unit as well as cost to manufacture. Transportation equipment demands vary which dictate varying forms of this embodiment. This embodiment has been presented in very general terms to convey only the general concept.

FIG. 12A Shown is a ¾ view of basic cab display unit. Each display unit 94 shown installed in cab display enclosure 207 may represent a tension monitoring device. Mounted on base 206 and possibly supplied power and data via optional power input means 208 unit may convey a large quantity of information to operator and through display user interface, operator can manipulate display content and visual read out options. Information at display may include: Time, heading, absolute tension, graduated tension, temperature, type of alarm, sound of alarm, event shock recording status, color coding, boost signal to remote, illumination trigger at tension sensing device, loss of signal alarm, low battery, solar recharge status, battery recharge status, tamper warning, silent alarm, moisture alarm, event replay, memory storage, status transmit via x means, satellite link, read convoy function, enter unit number, tension code, tension signal search, event download, wireless download, USB computer link, digital readout tension amount, set tension signal at X, display lights, display lights dimmer, reset, battery back-up.

FIG. 12B Shown is a ¾ view of optional portable display unit 217. Information conveyable through display face 210 can vary with each embodiment. Remote display enclosure 207 and detachable from wrist band 209 may contain options listed above and are selectable utilizing display user interface 211.

FIG. 13 Shown is an electrical schematic for basic tie down tension sensing embodiment. Power supply 214 energizes both circuits. On the signal creation side transducer unit 212 (located in association with tension sensing device) establishes a signal that is presented to wireless communication device 215. On the display side, wireless communication device 215 acquires an electrical signal and displays it through display 216.

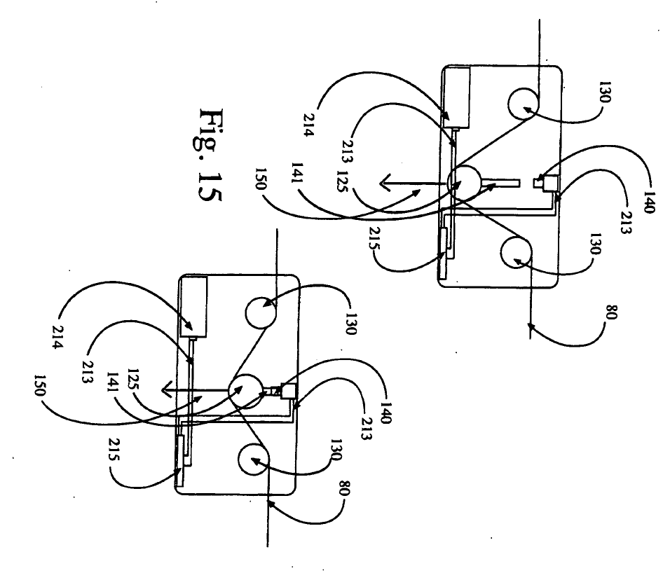

FIG. 14 Shown is a ¾ view of transported load 60 secured to transportation deck 70 with load securing straps 80, tightened with tensioning devices 85. Tension monitoring device 90 via variable means conveys tension information to one or both forms of display frame mounted display 94A or positionable display 94B.

FIG. 15 Shown is a schematic that conveys the general relationship between strap 80 tension and tension signal creation. The presiding principal of operation of the present invention is the basic premise that universal spring tension 150 is overcome by tension in tie strap 80 forming the creation of distance between electromagnetic initiator/trigger 141 and sensor/switch 140. The essence of spring tension can be provided by various forms including but not limited to: Compressive tensile metallic sources (coil spring), Extensive tensile metallic sources (coil spring) Flexor tensile metallic (leaf spring), compressive elastic composite (cushion), extensive elastic composite (stretchable component) or other. The essence of signal creation can be via electronic transducer means, electronic proximity sensing means, simple circuit completion means or other.

While numerous embodiments have been presented, close inspection will reveal that they all are utilizing the above mentioned rudimentary principals.

### REFERENCE NUMERALS

50 transportation unit

55 transportation unit frame

60 transported load

70 transportation deck

80 tie strap/load securing strap

88 signal conveyance device

85 tensioning device

90 tension monitoring device

92 tension information/signal

94 display unit

94A fixed, frame mount display

94B positionable display

96 portable display unit (man on FIG. 1)

98 sliding portion of tension sensing device

100 housing

100A upper housing

100B lower housing

101 Hinge

102 weather resistant slot

103 weather resistant enclosure

105 lock tabs

106 lock pin holes

107 lock pin

123 stationary tie strap segment

124 tension able tie strap segment

125 roller

130 pin/roller

131 tie-off pin/roller

140 sensor/switch

141 electromagnetic initiator/trigger

144 access panel

145 electrical component enclosure

150 spring/spring force

151 spring attachment point

159 closure knob

160 tensioning knob

161 male threads

162 female threads

170 shaft

180 texture teeth

185A first chain segment

185B second chain segment

186 slack in link chain

188 retaining clip

190 handle

195 ratchet mechanism

196 spool hub

200A open, loose boom

200B closed, tight boom

201 tension sensing unit

202 tensioning boom

203 tension sensing assembly

204 tension plunger

205 compressible bushing

206 display base

207 display enclosure

208 tension information/signal/power input means

209 portable display wrist band

210 portable display indicator face

211 portable display user interface

212 transducer device (sensor/switch 140 and electromagnetic initiator/trigger 141)

213 insulated conductive means

214 power supply

215 wireless communication device

216 display device

217 remote display device

1000 pivoting joint

1001 second pivoting joint

1002 chain linkage assembly

H hook

### Operation

In operating present invention as described with any of the included embodiments, user installs tension monitoring device on tie-strap/tie down securing transported load with properly installed, tension able tie-strap apparatus. At the point in which maximum installation tension of tie-strap and tensioning device has been achieved, operator at cab or remote display user interface actuates the “set” function and immediately, dedicated indicator 94 (FIG. 12A) indicates the status of “tight” or the accepted equivalent. Upon operator's satisfactory visual inspection of tie strap installation on transportation load and tie strap anchor points, and upon operator's confirmation that indicator 94 (FIG. 12A) reads “tight” operator sets out on transportation journey with secured load on trailer, in tow. Should transported load shift and settle and strap tension drop to an unsafe tension, cab display indicator will display exactly that information to the operator and immediately a suitable pull over location will be located and straps will be retightened and monitoring devices reset. Conveyance to operator can be via visual indicator and/or an auditory alarm. Visual indication could be of a digital or analog gage, needle indication and/or colored light display. Should a large pot hole be unavoidably struck causing significant compression on trailer suspension and accordingly a reduction in monitored tie-strap tension, cab and remote display indicators will display exactly that information to the operator and immediately a suitable pullover location will be located and straps will be retightened and monitoring devices reset. Should a traffic situation occur and cause the operator to immediately and seriously swerve, the vehicle to avoid an accident and following the incident, the tie-strap tension indicator displays still reads “tight” operator can proceed with confidence, knowing that load is still securely bound. This tension monitoring device promotes safety and peace of mind on the roadway. Because of the real time, instant information it provides to the operator, property damage and loss of life accidents are avoided by allowing operator to remedy load failure issues while they are small and well before they become catastrophic. It remains an additional advantage to the user of this device in that load tampering while at rest can be monitored while in a sleeping or eating environment. Other forms of display may include a light array affixed or positionable upon transport deck such that tie strap tension can be visually conveyed to transportation operator via light signal.

I claim:

1. A chain tensioning boom comprising:
a chain tensioning boom having a first pivoting joint connected to a chain linkage assembly that connects to a first chain segment that can be tensioned against a second chain segment;
said chain tensioning boom further comprising a second pivoting joint connected to a proximal end of a chain tension sensing unit that has a distal end with a tension plunger;
said tension plunger having a connection to the second chain segment;
said tension plunger having a sliding engagement inside the chain tension sensing unit;
a compressible member attached to the tension plunger inside the chain tension sensing unit so as to urge the tension plunger toward the proximal end of the chain tension sensing unit;
an electronic sensor means inside the chain tension sensing unit functioning to send an output signal when an electromagnetic initiator on the tension plunger passes a threshold distance from the electronic sensor means;
wherein closing the chain tensioning boom creates a desired load tension between the first chain segment and the second chain segment via the chain tensioning boom chain linkage assembly and the chain tension sensing unit;
wherein upon a decrease of the desired load tension the compressible member moves the tension plunger toward the proximal end of the chain tension sensing unit, thereby initiating the output signal from the electronic sensor; and
wherein said output signal is indicated on a remote display via a connection between the remote display and the electronic sensor.

2. The apparatus of claim 1, wherein the connection is a wireless connection, and the electronic sensor further comprises a transmitter.

3. The apparatus of claim 1, wherein the connection is a wired connection.

4. The apparatus of claim 1, wherein the chain linkage assembly further comprises a hook attached to the first chain.

5. The apparatus of claim 1, wherein the tension plunger linkage to the second chain segment further comprises a hook.

6. The apparatus of claim 1, wherein the compressible member is a bushing.

7. The apparatus of claim 1, wherein the compressible member is a spring.

8. A method for tensioning a chain, the method comprising the steps of:
securing a distal end of a first chain segment to a distal side of a cargo load;
passing the first chain segment around a cargo load;
connecting a proximal end of the first chain segment to a chain tensioning boom having a first pivoting joint connected to a chain linkage assembly;
connecting a second chain segment to a second pivoting joint of said tensioning boom;
creating a tension between the first and second chains using the chain tensioning boom;
sensing a decrease in the tension using a tension plunger;
initiating a signal upon sensing the decrease using an electromagnetic initiator on the tension plunger; and
transmitting the signal to a remote display.

9. The method of claim 8, wherein the transmission to the remote display is a wireless connection.

10. The method of claim 8, wherein the transmission to the remote display is a wired connection.

11. The method of claim 8, wherein the remote display is located in a truck cab.

12. The method of claim 8, wherein the remote display is located at a central control facility.
